(19) United States
(12) Patent Application Publication
(10) Pub. No.: US 2012/0140302 A1
(43) Pub. Date: Jun. 7, 2012

(54) MEMS-BASED OPTICAL IMAGE SCANNING APPARATUS, METHODS, AND SYSTEMS

(75) Inventors: Huikai Xie, Gainesville, FL (US); Lin Liu, Gainesville, FL (US)

(73) Assignee: University of Florida Research Foundation, Incorpo, Gainesville, FL (US)

(21) Appl. No.: 13/383,286

(22) PCT Filed: Aug. 26, 2010
(86) PCT No.: PCT/US10/46775

§ 371 Date: Jan. 10, 2012

Related U.S. Application Data
(60) Provisional application No. 61/239,619, filed on Sep. 3, 2009.

(51) Int. Cl. G02B 23/26; G02B 26/10

(52) U.S. Cl. 359/200.8; 359/210.1; 359/201.2; 359/197.1

(57) ABSTRACT

Disclosed are MEMS-based optical image scanners and methods for imaging using the same. According to one embodiment, a 3-D scanner for endoscopic imaging is provided, which includes a MEMS mirror for 1-D or 2-D lateral scanning and a MEMS lens for scanning along the optical axis to control the focal depth. The MEMS lens can be a microlens bonded to a MEMS holder. Both the MEMS holder and the MEMS mirror can be electrothermally actuated. A single-mode fiber can be used for both delivering the light to and receiving the returning light from an object being examined.

### CROSS-REFERENCE TO RELATED APPLICATION

This application claims the benefit of U.S. Provisional Application Ser. No. 61/239,619 filed Sep. 3, 2009, which is hereby incorporated by reference in its entirety, including all figures, tables and drawings.

The subject invention was made with government support under Grant Nos. 0423557 and 0818473 awarded by the National Science Foundation. The government has certain rights in the invention.

### BACKGROUND OF INVENTION

Confocal microscopy and nonlinear optical (NLO) microscopy are powerful imaging techniques that are routinely used in many fields such as biological observation, chemical analysis and industrial inspection.

In confocal microscopy, a light source, such as a laser beam, is focused by an objective lens into a small focal volume within or on the surface of a specimen. Scattered and reflected light from the illuminated spot is then re-collected by the objective lens. A beam splitter is used to direct the light from the light source to the specimen and the returned light to a photodetection device. A spatial pinhole is used to eliminate out-of-focus light returned from specimens.

A similar procedure is used for NLO microscopy except that no pinhole is needed. Instead, the beam splitter is dichroic so that the excitation light will be filtered out and only allow the NLO signal to pass and be collected by the photodetector. NLO microscopy includes two-photon or multiphoton microscopy and second-harmonic-generation microscopy.

The advantages of confocal and NLO microscopy are the high contrast and high resolution capabilities, and the optical sectioning capacity.

However, standard confocal and NLO microscopes have large-sized optical systems. Therefore, specimens cannot be observed in vivo by the standard bulky confocal or NLO microscopes. Instead, specimens are removed from the living body (or other entity) and mounted onto slides for in vitro observation.

To realize in vivo, real time cross-sectional imaging, it is necessary to miniaturize the optical system of the confocal or NLO imaging system.

A first step of miniaturization can be realized by using optical fiber as the transmission medium. The fiber optical confocal scanning microscope is smaller than standard confocal microscopes, but remains too large for in vivo imaging. The fiber optical confocal scanning microscope utilizes the core of single mode fibers as the pinhole. However, a miniature scanning mechanism is also required to get real time in vivo images.

An example of a scanner based on successively illuminating the different fibers in an image guide comprising of a bundle of flexible fibers has been proposed by Le Gargasson et al. in U.S. Pat. No. 6,470,124. The scanning unit disclosed by Le Gargasson et al. produces successive angular deflections of the illuminated light from a source. A lens converts the angular deflections to lateral deflections, which correspond to different fibers' entry in the image guide. The microscope objectives focus the light from different fibers to different focal points. Though this method provides a fiber optic approach to imaging, the microscope objectives limit the miniaturization capabilities of this design, making it difficult to meet the desired dimension for endoscopic imaging. In addition, the distortion of images may be induced during scanning of the fibers; and the specular reflection at the face of the fiber bundle is also a problem in this design. Furthermore, the resolution is limited by the discrete characteristics of the cores in the fiber bundle.

Confocal and NLO imaging requires both lateral scanning and depth scanning of a specimen. Current confocal and NLO imaging relies on a movable carriage for depth scanning using manual manipulation of, for example, a probe, or mechanical translation of, for example, the end of a fiber. However, these approaches tend to have poor reliability in the mechanical translation, instability of light coupling, and provide difficulty in miniaturizing the scanning section to an acceptable dimension for endoscopic imaging.

Microelectromechanical systems (MEMS) have become attractive for miniaturizing optical scanning systems. In particular, MEMS mirrors are being utilized for their lateral scanning capabilities. However, the designs continue to be challenging when attempting to meet the stringent size requirements of endoscopic imaging. For example, the axial scanning requirement (depth scanning) continues to be the bottleneck for confocal and NLO microendoscopy.

Accordingly, research continues to be conducted to provide an optical image scanning apparatus that can be applied to microendoscopy.

### BRIEF SUMMARY

Embodiments of the present invention provide MEMS-based optical image scanning. Light scanners are disclosed that can be suitable for endoscopic imaging applications. The endoscopic imaging applications can include confocal endoscopic imaging and nonlinear optical imaging. According to an aspect of the invention, light scanners are provided that can be miniaturized to sizes that can be inserted into the living body for real time endoscopic imaging.

The subject light scanners can be constructed using a MEMS mirror and/or MEMS lens in accordance with embodiments of the present invention. The MEMS lens refers to a microlens integrated into a MEMS lens holder. The MEMS mirror can be used to redirect a light beam and scan laterally, while the MEMS lens can be used to control the focal depth and scan axially.

The MEMS mirror and MEMS lens can have similar structures (differing in the mirror plate and lens portions) and can be actuated by electrothermal actuators that can achieve large scanning angles, large vertical displacement with minimal lateral shift, fast scanning, small size, and low operating voltage.

According to one embodiment, a one-dimensional (z direction) light scanner is provided that incorporates a MEMS lens. The MEMS lens can be actuated within a miniature head of a probe without the use of a movable stage.

According to another embodiment, a two-dimensional (x and y directions) light scanner is provided that incorporates a fixed objective lens and a MEMS mirror.

According to another embodiment, a three-dimensional (x, y, and z directions) light scanner is provided that incorporates a fixed objective lens and a MEMS mirror, where the z direction scan is obtained by the piston movement of the MEMS mirror.

According to yet another embodiment, a three-dimensional (x, y, and z directions) light scanner is provided that incorporates a MEMS mirror and a MEMS lens.

For a confocal imaging application according to one embodiment of the present invention, a probe is provided including a collimating lens, and a light scanner capable of receiving the collimated beam from the collimating lens and directing the beam onto an object. The probe is connected to a single fiber, which is used for both illuminating and detecting. The single fiber can be a single-mode fiber, which provides the pinhole that blocks out-of-focus light.

The light scanner can be a 1-D, 2-D, or 3-D light scanner in accordance with embodiments of the present invention. In one embodiment, a single GRIN lens can be used for collimating. In addition, for embodiments using the MEMS lens, such as for the 1-D and 3-D light scanners, the MEMS lens is used for focusing and depth scanning. For embodiments using the MEMS mirror, such as for the 2-D and 3-D light scanners, a single MEMS mirror is used for lateral scanning.

### BRIEF DESCRIPTION OF DRAWINGS

FIG. 1 shows a 1-D light scanner using MEMS lens to actively tune the depth of the focal point according to an embodiment of the present invention.

FIG. 2 shows a miniature endoscopic probe design for 1-D light scanner according to an embodiment of the present invention.

FIG. 3 shows a 2-D light scanner using a MEMS mirror and a fixed objective lens in accordance with an embodiment of the present invention.

FIG. 4 shows a 2-D light scanner using a MEMS minor and a fixed objective lens in accordance with another embodiment of the present invention.

FIG. 5 shows a 3-D light scanner for confocal endoscopic imaging by using a MEMS mirror and a MEMS lens according to an embodiment of the present invention.

FIG. 6 shows a miniature endoscopic probe design for 3-D light scanner according to an embodiment of the present invention.

FIG. 7 shows a diagram of a confocal endoscopic imaging system based on a fiber optical system and a miniaturized light scanner in accordance with an embodiment of the present invention.

FIG. 8 shows a schematic of a three-bimorph actuator with large vertical displacement and no lateral shift that can be incorporated in a MEMS mirror and MEMS lens according to an embodiment of the present invention.

FIG. 9 shows a MEMS mirror design based on the large-vertical-displacement lateral-shift-free bimorph actuator that can be used for applications in accordance with embodiments of the present invention.

FIGS. 10A-10H show an exemplary fabrication process flow of a MEMS mirror in accordance with an embodiment of the present invention.

FIGS. 11A and 11B show SEM images of a MEMS mirror and a MEMS lens.

FIG. 12 shows a diagram of a fiber-optic confocal microscope system according to an embodiment of the invention.

### DETAILED DISCLOSURE

Embodiments of the present invention provide a MEMS-based scanning apparatus. In accordance with embodiments of the present invention, miniature light scanners for endoscopic confocal or NLO imaging based on MEMS mirrors and a MEMS lens are provided. Confocal microscopy and NLO microscopy are powerful imaging techniques now routinely used in many fields, such as biomedical imaging, chemical analysis and industrial inspection. Their major advantages are high contrast and high resolution capabilities, and the optical sectioning capacity. However, since standard confocal and NLO microscopes have large optical systems, the tissues cannot be observed in vivo by a standard bulky confocal or NLO microscope. Instead, tissues are removed from the living body and mounted onto microscope slides for in vitro observation.

To realize in vivo real-time confocal or NLO imaging, the optical scanning system is miniaturized. By using optical fibers as a transmission medium, a first step of miniaturization can be accomplished. However, to image non-stationary tissues, especially for medical in vivo imaging, it is necessary to further miniaturize optical scanners so that the scanning section could be inserted into the living body for real time endoscopic imaging.

According to certain embodiments of the present invention, MEMS mirror- and MEMS lens-based scanning apparatuses are provided for imaging applications. The MEMS mirror can be used to redirect an optical beam and scan the optical beam laterally. The MEMS lens can be used to control the focal depth and can be scanned along the optical axis (i.e. axially).

According to one aspect, since the MEMS mirror and MEMS lens have small size, the imaging probe can be miniaturized to apply to endoscopic imaging. Real-time imaging can also be achieved because of the fast scanning. Embodiments of the present invention can be used for confocal microscopy and nonlinear optical imaging.

According to an embodiment of the present invention, a confocal endoscope is provided with 3-D scanning capability. A single 2-D MEMS mirror is used to scan light laterally and a MEMS lens is used to scan the light axially. In addition, a single fiber can be used for both illuminating and detecting light. Implementations of the present invention can be used in a variety of applications including, but not limited to, confocal endoscopy for cancer detection, optical biopsy, minimally invasive imaging, image-guided surgery, surgical monitoring, and in vivo imaging.

Advantageously, 3-D scanning can be realized using a single MEMS mirror and MEMS lens without using an external galvanometer to determine depth. In addition to 3-D scanning, the subject scanners can achieve miniature size, fast speed, large scanning ranges, low voltage, and low cost.

In an embodiment, the MEMS components can utilize electrothermal actuation. In a specific embodiment, thermal bimorph beams are used to actuate the MEMS mirror and the MEMS lens.

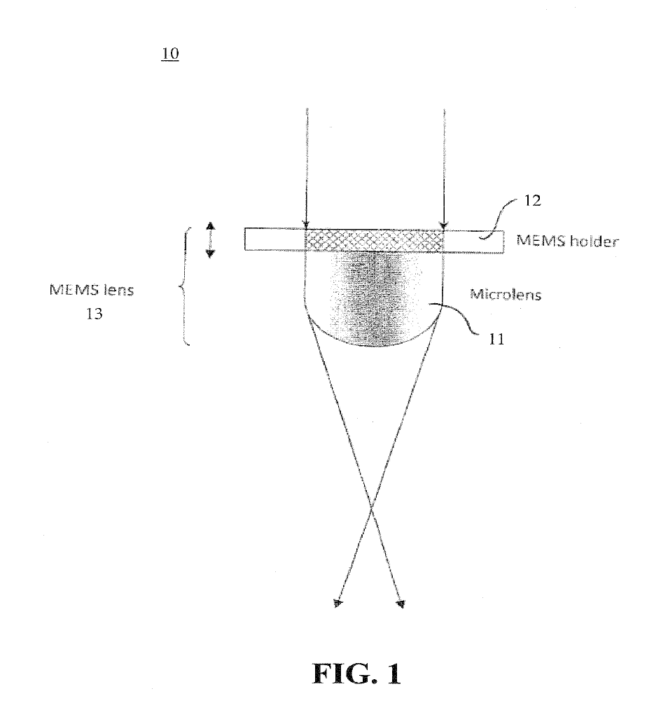

FIG. 1 shows a schematic of a 1-D light scanner 10 according to an embodiment of the present invention. The one-dimensional light scanner 10 can generate tunable focusing by vertically actuating a microlens 11. The microlens 11 is bonded to a MEMS lens holder 12 that allows vertical actuation. In operation, the microlens 11 moves vertically together with the holder 12 to focus the light to different vertical positions. The combination of microlens 11 and holder 12 can be referred to as a MEMS lens 13. The lens holder 12 can be fabricated by a combined surface-micromachining and bulk-micromachining process. The lens holder 12 can have a platform with a central opening for passing the light. In one embodiment, the lens holder 12 can be a transparent meshed SiO₂ patterned platform to support the microlens 11. Four sets of actuators (not shown) can be disposed surrounding the platform to generate piston motion of the platform. When the actuators vertically actuate the platform, the microlens 11 bonded to the platform will also move up and down accordingly, thereby tuning the vertical position of the focal plane.

The actuators can be designed to generate large piston motion of the microlens, for example, up to 800 μm, which results in a large tunable range of the focal plane (hundreds of microns to a few mm).

By using actuators in accordance with certain embodiments of the present invention, the platform (holder 12) can be maintained parallel to the substrate with a very small tilting angle (˜0.7°) in the full vertical scanning range. According to embodiments for confocal imaging applications using such a structure, errors caused by the tilting of the microlens, which leads to undesired and uncontrollable change of the focal plane, can be minimized.

In addition, the lateral shift of the platform (holder 12) is small (˜10 μm) in the full vertical scanning range. In particular, during the piston motion, the lateral position of the microlens can be consistent (i.e. any change in the lateral position is minimal). Thus, the focal point is nearly free of lateral shift during the axial scanning.

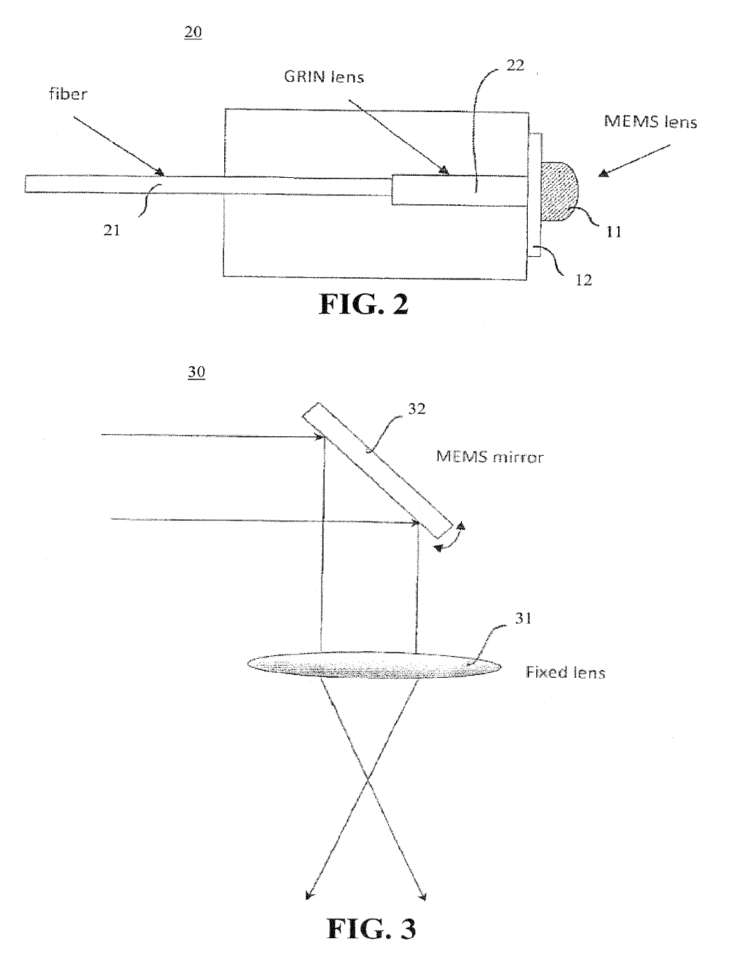

The 1-D confocal light scanner described with respect to FIG. 1 can be incorporated in a miniature endoscopic probe 20 for endoscopic confocal imaging as shown in FIG. 2. For example, referring to FIG. 2, light from a fiber 21 is collimated by a GRIN lens 22, passes the transparent meshed SiO₂ or central opening in the platform 12, and is then focused by the microlens 11 onto an object. The backscattered light is collected by the microlens 11, and passed to the fiber 21. The small core of the single mode fiber can eliminate or substantially remove out-of-focus light, and couples only the backscattered light from the focal point.

Referring to FIG. 3, for a two-dimensional light scanner 30 in accordance with an embodiment of the present invention, a fixed objective lens 31 is used for light focusing and large numerical aperture (NA), and a two-dimensional (2-D) MEMS mirror 32 is used for 1-D or 2-D lateral scanning. The MEMS mirror 32 serves as a transverse scanning mirror with 2-D rotations. The MEMS mirror is also actuated with four symmetric large-vertical-displacement, lateral-shift-free actuators. The MEMS mirror has fast scanning speed and large scanning angles. The scanning speed could satisfy the requirement of real-time imaging and the scanning angles could give a large lateral scanning range.

In operation, light is redirected by the transverse scanning mirror (MEMS mirror 32) to the fixed lens 31, and then focused by the fixed objective lens 31 to a focal point.

According to certain implementations, the 2-D scanner as described with respect to FIG. 3 can be used for a hand-held confocal imaging apparatus, integrated with a traditional confocal microscope for endoscopic imaging applications, or integrated with axial scanning motors/actuators for 3-D scanning. Of course, embodiments are not limited thereto. This 2-D scanner can also be integrated into an endoscopic probe with a miniature size and good alignment.

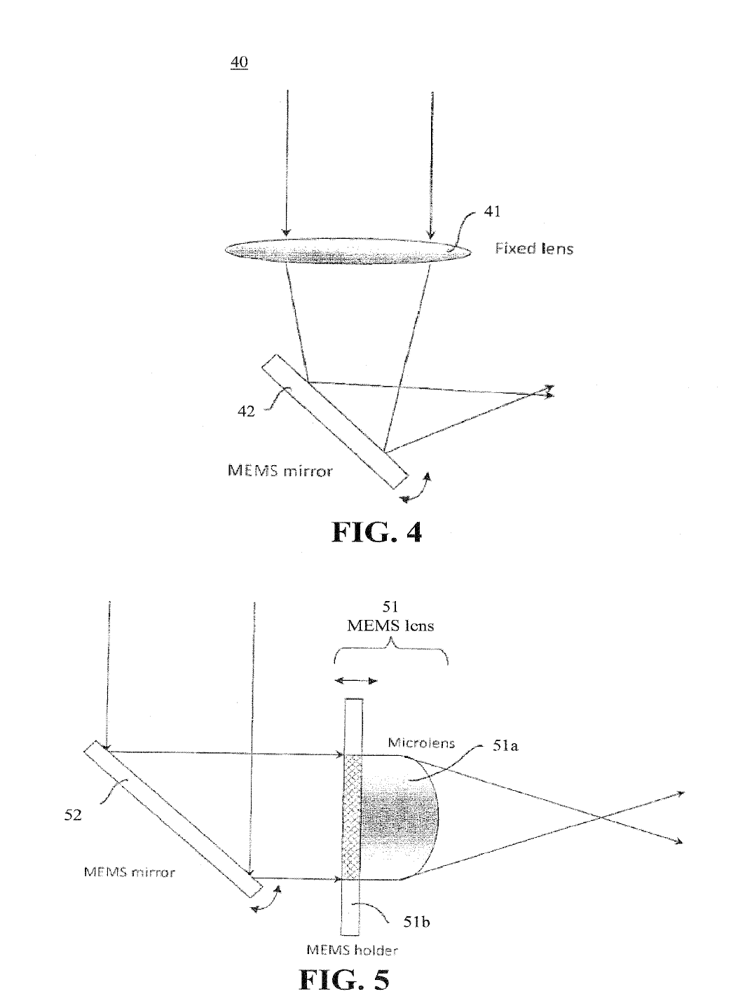

FIG. 4 illustrates another embodiment of a 2-D light scanner. Referring to FIG. 4, the scanner 40 includes an objective lens 41 with long focal length and a 2-D scanning MEMS mirror 42. In operation, light focused by the fixed objective lens 41 strikes on the MEMS mirror 42 and is laterally scanned by the MEMS mirror 42.

In a further embodiment, a z direction scan can be obtained by the piston movement of the MEMS mirror (32 or 42).

In addition to the 1-D and 2-D light scanners, embodiments of the present invention can provide a 3-D light scanner as shown in FIG. 5, which combines the one- or two-dimensional lateral scanning from the MEMS mirror with the one-dimensional depth from the MEMS lens. Here the MEMS mirror still serves as transverse scanning mirror in two dimensions, and the MEMS lens offers axial depth scanning to add another scanning dimension.

FIG. 5 shows a schematic of a 3-D light scanner in accordance with an embodiment of the present invention. Referring to FIG. 5, light strikes on a scanning MEMS mirror 52 and is redirected to a MEMS lens 51, which focuses the light to a focal point. The scanning MEMS mirror 52 can be a 2-D scanning MEMS mirror that can redirect the beam and scan in x and in y directions. MEMS lens 51 can be a tunable MEMS lens in order to add the depth scanning. The MEMS lens 51 can include a microlens 51a and a holder 51b configured as described with respect to the microlens 11 and the holder 12 of FIG. 1. Due to the large scanning angle of the MEMS mirror 52 and the large piston motion of the MEMS lens 51, the 3-D scanner can have both a large range of lateral scan and a large range of vertical scan.

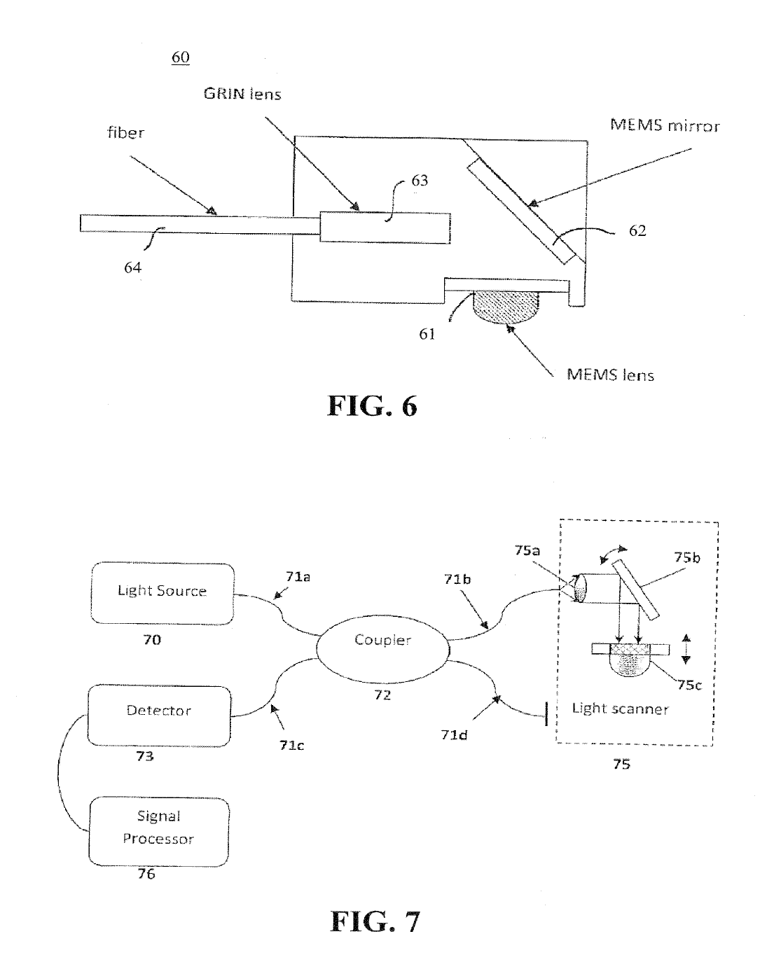

The 3-D light scanner described with respect to FIG. 5 can be incorporated in a miniature endoscopic probe 60, as shown in FIG. 6. The endoscopic probe 60 can be used for endoscopic confocal imaging, endoscopic two-photon imaging, endoscopic second-harmonic-generation imaging, and endoscopic optical coherence microscopy, but embodiments are not limited thereto. Because of the small size of the MEMS mirror 52 and MEMS lens 51, the scanner can be made small enough for endoscopic imaging. Referring to FIG. 6, a probe 60 can be provided by incorporating a MEMS lens 61, MEMS mirror 62, and GRIN lens 63 that are aligned. Here, light transmitted out of a fiber 64 is collimated by the GRIN lens 63 and then strikes on the MEMS mirror 62. The 2-D scanning MEMS mirror 62 redirects the beam and scans in the x and in the y directions. Light is then focused by the MEMS lens 61 to a focal point.

FIG. 7 shows a confocal endoscopic imaging system according to an embodiment of the present invention, incorporating a fiber optical system and a miniature 3-D light scanner. Referring to FIG. 7, a confocal endoscopic imaging system according to an embodiment can include a light source 70, a transmitting medium, a 2×2 light coupler 72, a light detector 73, a signal processor 74 and a miniature light scanner 75. The light source 70 can be a laser. The transmitting medium can be fiber. In a preferred embodiment, the transmitting medium is single mode fiber. The light coupler 72 is connected to the fiber(s) (71a, 71b, 71c, 71d) and serves to distribute the transmitted light. Though the light coupler is described as a 2×2 light coupler, embodiments are not limited thereto. The light scanner 75 can be provided in the form of a miniature endoscopic probe and connected to one fiber end 71b. For example, the light scanner 75 can be made into a miniature head to be inserted into an inner body.

The light emitted from the laser source 70 is coupled into the single mode fiber 71a and transmitted to the light coupler 72. A portion of the light comes out of one terminal 71b of the coupler 72, is collimated by a. GRIN lens 75a of the light scanner 75 at the fiber end 71b, redirected by the 2-D scanning MEMS mirror 75b of the light scanner 75, and then focused by the tunable MEMS lens 75c of the light scanner 75 onto an object. Light returning from the object is collected by the MEMS lens 75c, redirected by the MEMS mirror 75b, and then focused by the lens 75a to the core of the end of the single mode fiber 71b. The core of the end surface of the fiber 71b has a conjugate relation with the focal point of the MEMS lens 75c. The single mode fiber is preferred because of its small fiber core, but embodiments are not limited thereto. The small core serves as the pinhole of the fiber optic confocal microscope to suppress out-of-focus returning light. A portion of the light is transmitted by the fiber 71c to the detector 73 through the coupler 72. The detector 73 then sends the detected signal to a signal processor 76.

This system can be modified in various ways. For example, according to one embodiment, a beam splitter can be used in place of the fiber coupler 72. In a further embodiment, polarization can be performed to screen out-of-focus light by the inclusion of a polarizing beam splitter, polarization-maintaining single fiber and quarter wave plate in place of the coupler 72 and single mode fibers (71a, 71b, 71c, 71d). According to another embodiment, an optical filter is placed in between the fiber 71c and the detector 73, and then the system can be used for two-photon microscopy or second-harmonic microscopy. According to yet another embodiment, an optical delay line is attached the end of the fiber 71d, and then the system can be used for optical coherence microscopy.

Though the light scanner 75 has been described as a 3-D light scanner, embodiments are not limited thereto. For example, the light scanner 75 can be a 1-D light scanner, a 2-D light scanner or a 3-D light scanner as described with respect to embodiments of the present invention.

In addition, according to an embodiment, the collimator for the light scanner 75 can be a GRIN lens, aspheric lens, or other collimating lens. In another embodiment, the beam from the tight source 10 can enter the light scanner 75 to be redirected by the MEMS mirror without being collimated.

According to certain embodiments, the light scanner 75 can be provided as a miniature probe to be inserted into an inner region of a body.

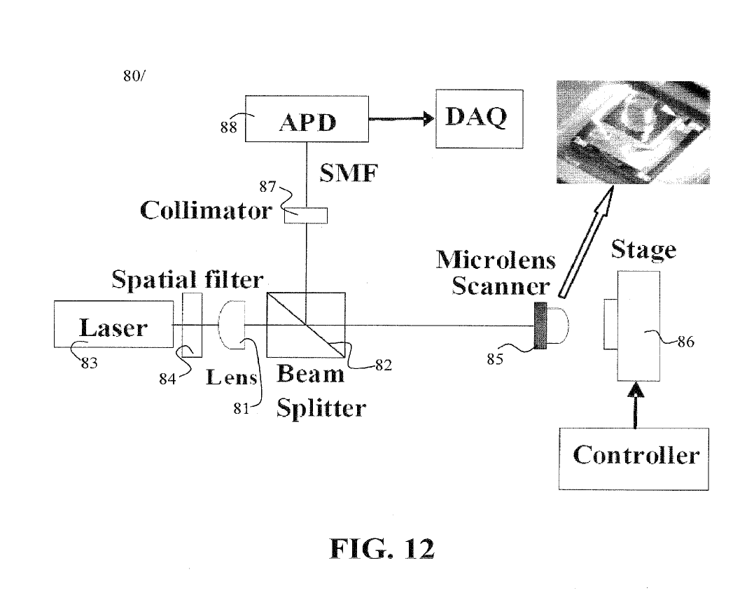

FIG. 12 shows a confocal microscope system according to an embodiment of the invention. In the confocal microscope system 80, incoming light is collimated by a lens 81 and then split into two paths by a beam splitter 82. The incoming light can be provided by a laser light source 83. A spatial filter 84 can be used to filter and “clean up” the light emitted from the laser light source 83 before being collimated by the lens 81 and directed to the beam splitter 82. At the beam splitter 82, half the light is directed to the sample arm, and focused into the sample by a microlens scanner 85 having a MEMS lens (see inset) in accordance with an embodiment of the invention. While the light is directed to the sample arm, the MEMS lens of the microlens scanner 85 scans the focal point axially, thereby imaging different depths of the sample. In one embodiment, a stage 86 can be used to laterally translate the sample. The reflected light from the sample can be collected by the MEMS lens of the microlens scanner 85, split by the beam splitter 82, coupled into a single-mode fiber by a fiber collimator 87, and detected by a photodiode 88. In one embodiment, the photodiode is an avalanche photodiode (APD). The single-mode fiber acts as a pinhole, substantially eliminating out-of-focus light. Accordingly, in certain embodiments, the subject MEMS lens can be utilized for automatic depth scanning in confocal microscopes.

The subject MEMS mirrors and MEMS lenses used in light scanners according to embodiments of the present invention are capable of vertical displacement with minimal lateral shift. To accomplish this feature, embodiments of the present invention can utilize large-vertical-displacement lateral-shift-free bimorph actuators with large scanning angles and fast scanning speed.

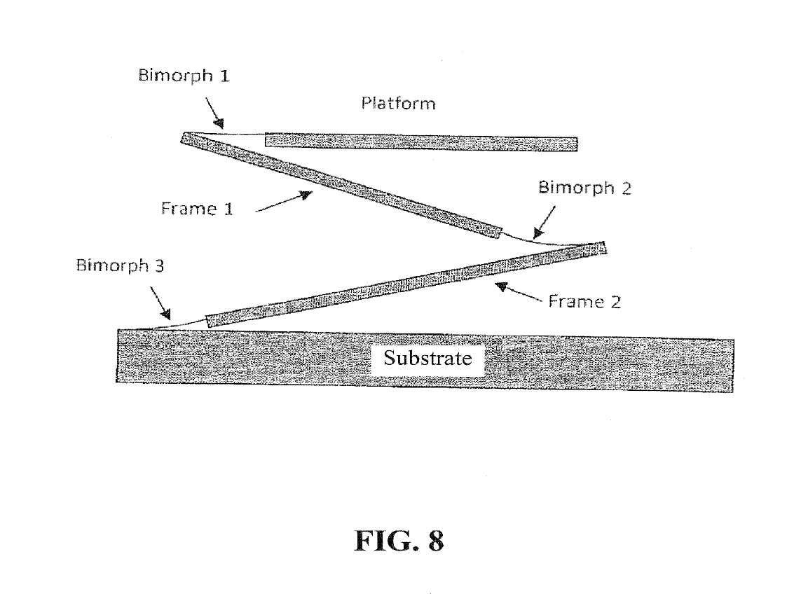

FIG. 8 shows a schematic of one design of such an actuator. Referring to FIG. 8, the actuator includes three complementary sets of bimorph beams and two frames connected between these bimorph beams. These three complementarily-oriented sets of bimorph beams can keep the platform parallel to the substrate by canceling the angular rotating during the actuating. Also by carefully designing the geometry of the actuators (mainly the length of the frames and the length of the bimorph beams), the folded structure can give zero lateral shift during actuating. The large vertical displacement of the actuator comes from the accumulating of the large vertical displacement at the tip of two frames. The long lengths of the frames turn the tilting angles at the end of the bimorphs into large vertical displacements at the end of the frames. In a specific embodiment, the actuator includes three complementary sets of Al/SiO₂ bimorph beams. The platform and the frames can have single crystal silicon underneath for rigidity and flatness. Heaters are embedded in the bimorph beams to generate Joule heating in presence of applied voltages. Because the Al and SiO₂ layers in the bimorph beam have different temperature coefficients of expansion (TCEs), when temperature changes due to Joule heating, a stress will be introduced and the bimorph beams will bend.

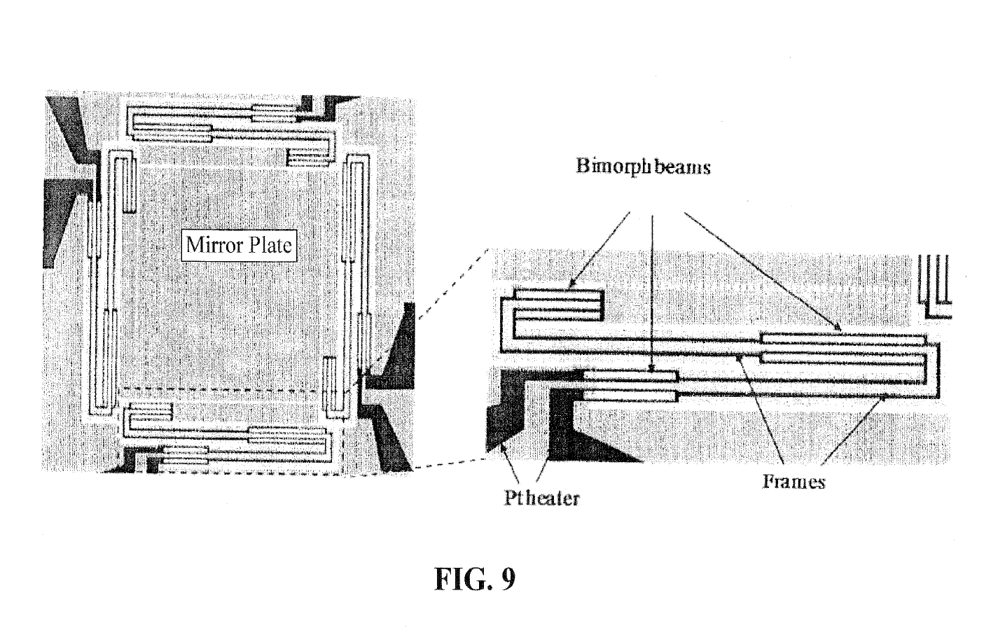

FIG. 9 shows a top view of a MEMS mirror having the large-vertical-displacement lateral-shift-free bimorph actuator of FIG. 8. As shown in FIG. 9, there are four symmetric sets of identical actuators surrounding the four sides of the mirror plate.

The MEMS lens holder can have the same or similar design as the MEMS mirror shown in FIG. 9 where a platform supporting a microlens is disposed in the location of the mirror plate of FIG. 9. To obtain piston motion, four symmetric actuators are driven simultaneously. By differentially driving the two opposite actuators, the MEMS mirror and MEMS lens can achieve two-dimensional scanning.

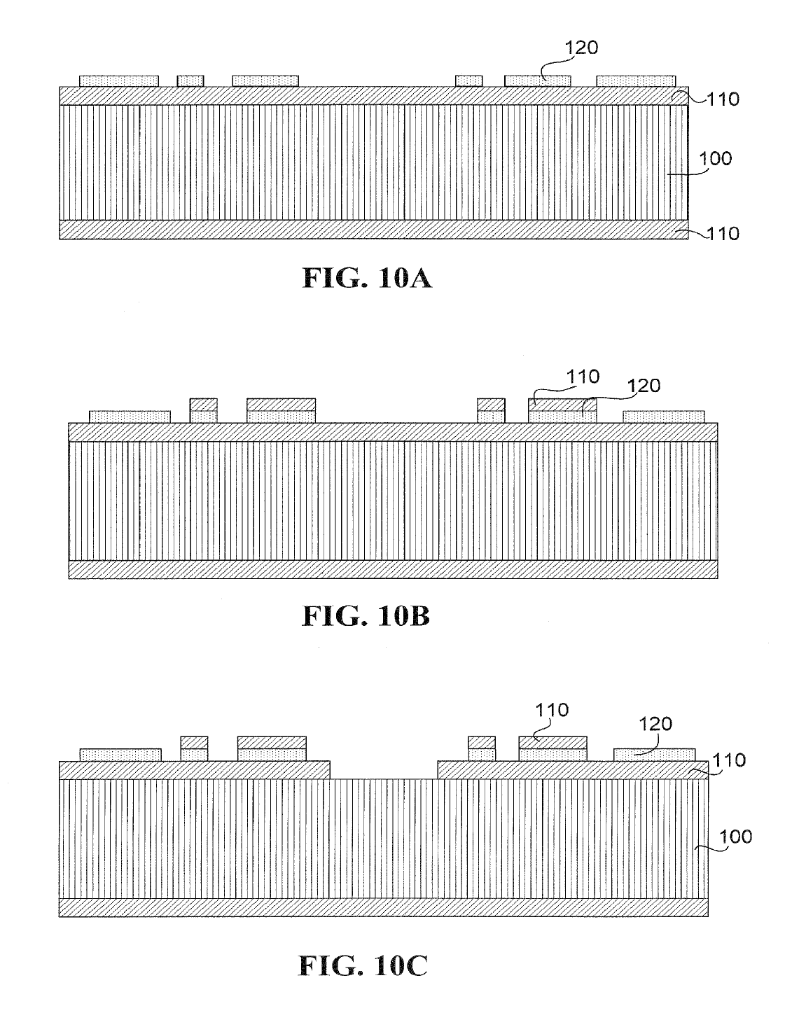

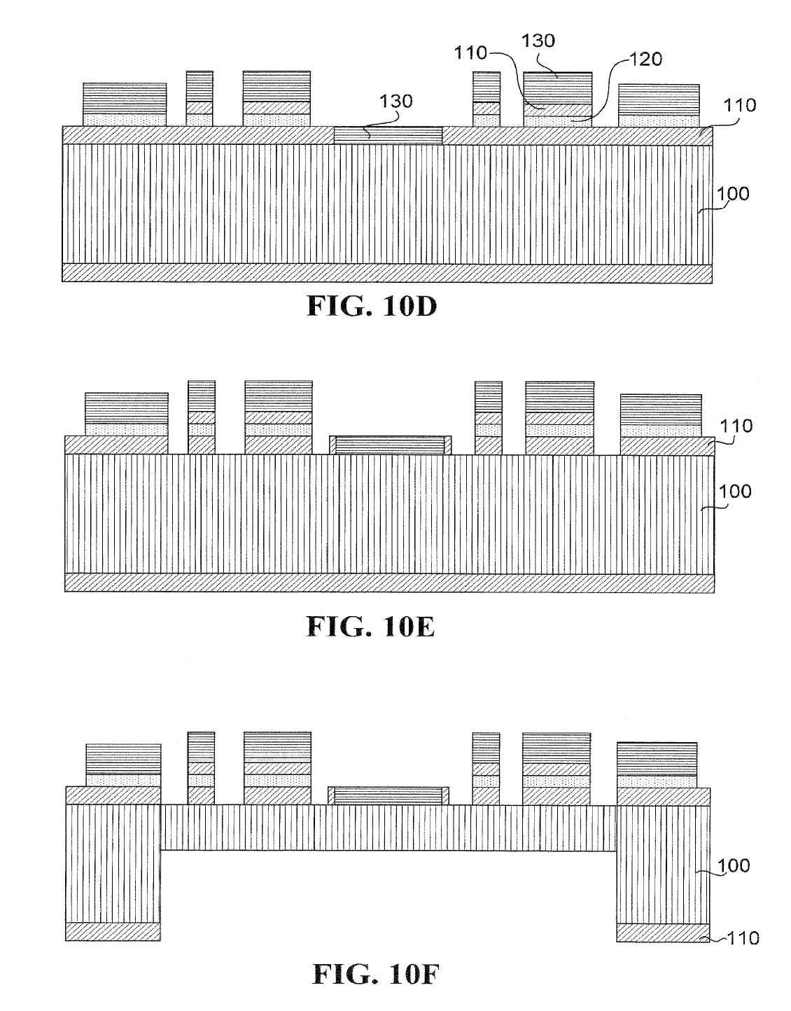

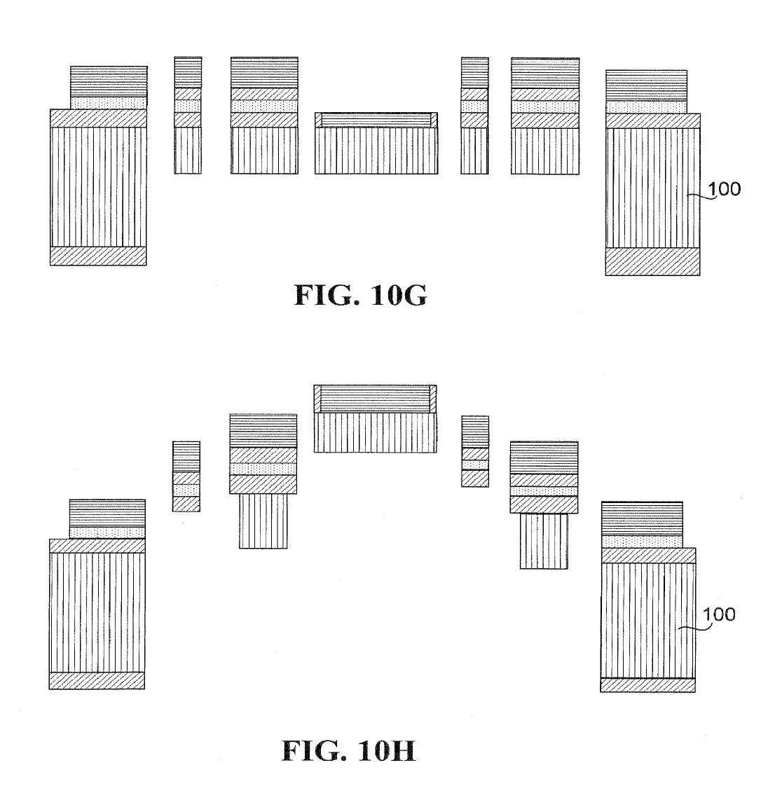

The fabrication of the MEMS mirror and the MEMS lens can utilize a combination of surface micromachining and bulk micromachining. FIGS. 10A-10H show an exemplary fabrication process flow of the MEMS mirror. The microlens shares nearly the same fabrication process with the MEMS mirror, only differing in the releasing step. In the figures, silicon is indicated by reference 100, silicon dioxide (SiO₂) is indicated by reference 110, platinum (Pt) is indicated by reference 120, and aluminum (Al) is indicated by reference 130.

Referring to FIG. 10A, a Pt heater is patterned on a 1 μm thermal oxide coated silicon wafer by sputtering and liftoff. Then, referring to FIG. 10B, a 0.1 μm isolation PECVD SiO₂ layer is deposited. After that, SiO₂ over the bonding pads and the mirror plate area is etched as shown in FIG. 10C. Next, referring to FIG. 10D, a 1 μm Al layer is deposited by e-beam evaporation and then lift-off is carried out to pattern the bimorph beams and the mirror plate. Then, a front-side plasma etch of SiO₂ is performed to define the bimorph beams as shown in FIG. 10E. Referring to FIG. 10F, after the front-side etch, a back-side etch is performed to define the 20 μm thick Single Crystal Silicon (SCS) beneath the frame and the mirror plate. This step can include a backside oxide etch and backside silicon etch by DRIE. Next, referring to FIG. 10G, the wafer is diced and a front-side deep silicon anisotropic etch is performed to etch through the SCS. Then, referring to FIG. 10H, an isotropic silicon etch is performed to undercut the silicon under the bimorph beams to release the devices. It should be noted that the material thicknesses, material selection, and method steps are provided as an exemplary embodiment, and should not be construed as limiting.

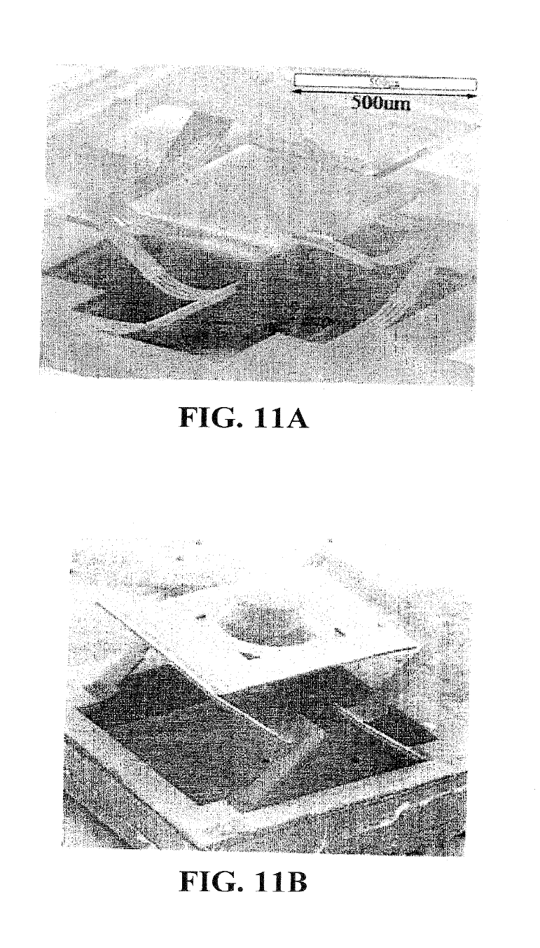

FIGS. 11A and 11B show scanning electron micrographs of a MEMS mirror and a MEMS lens, respectively. The lens may be a polymer lens formed by polymer reflow. The lens can also be pre-made and then assembled on a MEMS holder. In this case, the lens may be a plastic lens or a glass lens. FIG. 11B shows a glass lens assembled on a MEMS holder.

All patents, patent applications, and publications referred to or cited herein are incorporated by reference in their entirety, including all figures and tables, to the extent they are not inconsistent with the explicit teachings of this specification.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. More particularly, various variations and modifications are possible in the component parts and/or arrangements of the subject combination arrangement within the scope of the disclosure, the drawings and any appended claims. In addition to variations and modifications in the component parts and/or arrangements, alternative uses will also be apparent to those skilled in the art.

It should be understood that the examples and embodiments described herein are for illustrative purposes only and that various modifications or changes in light thereof will be suggested to persons skilled in the art and are to be included within the spirit and purview of this application.

1. An optical image scanning apparatus, comprising:
a MEMS lens for axial scanning.

2. The optical image scanning apparatus according to claim 1, wherein the MEMS lens comprises an electrothermally actuated holder and a microlens on the holder.

3. The optical image scanning apparatus according to claim 2, wherein the holder comprises:
a platform upon which the microlens is bonded; and
a plurality of electrothermal actuators surrounding the platform to generate piston motion of the platform.

4. The optical image scanning apparatus according to claim 3, wherein the platform comprises a central opening for passing light to the microlens.

5. The optical image scanning apparatus according to claim 3, wherein the platform comprises a transparent membrane for passing light to the microlens.

6. The optical image scanning apparatus according to claim 3, wherein the platform is transparent to the light employed.

7. The optical image scanning apparatus according to claim 1, further comprising one optical fiber for illuminating light to the MEMS lens and receiving detected light.

8. The optical image scanning apparatus according to claim 1, further comprising:
a MEMS mirror for 1-D or 2-D lateral scanning; and
one optical fiber for illuminating light to the MEMS lens and receiving detected light,
wherein the MEMS lens focuses the light halfway to the MEMS lens which then scans the final focal point laterally.

9. The optical image scanning apparatus according to claim 1, further comprising:
a MEMS mirror for 1-D or 2-D lateral scanning; and
one optical fiber for illuminating light to the MEMS mirror and receiving detected light,
wherein the MEMS mirror redirects the light from the one optical fiber to the MEMS lens, the MEMS lens then focusing the light to a focal point.

10. The optical image scanning apparatus according to claim 9, further comprising a collimating lens between the one optical fiber and the MEMS mirror.

11. The optical image scanning apparatus according to claim 10, wherein the collimating lens, the MEMS lens, and the MEMS mirror are disposed in an endoscopic probe.

12. The optical image scanning apparatus according to claim 9, wherein the MEMS lens comprises a holder and a microlens on the holder, wherein the holder comprises:
a platform supporting the microlens, and
a first plurality of electrothermal actuator sets surrounding the platform to generate piston motion of the platform;
wherein the MEMS mirror comprises a mirror plate and a second plurality of electrothermal actuator sets surrounding the mirror plate.

13. The optical image scanning apparatus according to claim 12, wherein each electrothermal actuator set of the first plurality and second plurality of electrothermal actuator sets comprises:
three complementary sets of metal/oxide bimorph beams;
a heater embedded in each of the three complementary sets of metal/oxide bimorph beams, the heater generating Joule heating in presence of an applied voltage;
a first frame between a first and a second of the three complementary sets of metal/oxide bimorph beams; and
a second frame between the second and a third of the three complementary sets of metal/oxide bimorph beams.

14. An endoscopic imaging system comprising:
a light source;
a beam splitter;
a light detector; and
a MEMS-based light scanner configured within an endoscopic probe,
wherein the beam splitter directs at least a portion of light from the light source to the MEMS-based light scanner and directs at least a portion of returning light from the MEMS-based light scanner to the light detector.

15. The endoscopic imaging system according to claim 14, wherein the beam splitter is a 2×2 single-mode fiber coupler, wherein light emitted from the light source is coupled to the fiber coupler, the fiber coupler directing half the light emitted from the light source to the MEMS-based light scanner;
wherein the returning light scattered back from a sample is coupled to the fiber coupler through the MEMS scanner, wherein the fiber coupler directs half the light returned from the MEMS scanner to the light detector.

16. The endoscopic imaging system according to claim 14, wherein the MEMS-based light scanner is a 1-D light scanner comprising:
a MEMS lens for axial scanning, wherein the MEMS lens comprises a holder and a microlens on the holder, wherein the holder comprises:
a platform supporting the microlens; and
a plurality of electrothermal actuators surrounding the platform to generate piston motion of the platform.

17. The endoscopic imaging system according to claim 14, wherein the MEMS-based light scanner is a 2-D light scanner comprising:
a fixed objective lens; and
a MEMS mirror, wherein the MEMS mirror comprises a mirror plate and a plurality of electrothermal actuator sets surrounding the mirror plate.

18. The endoscopic imaging system according to claim 14, wherein the MEMS-based light scanner is a 3-D light scanner comprising:
a single MEMS mirror for 1-D or 2-D lateral scanning, wherein the MEMS mirror comprises a mirror plate and a first plurality of electrothermal actuator sets surrounding the mirror plate; and
a MEMS lens for axial scanning, wherein the MEMS lens comprises a holder and a microlens on the holder, wherein the holder comprises:
a platform supporting the microlens, and
a second plurality of electrothermal actuator sets surrounding the platform to generate piston motion of the platform;
wherein light transmitted from the beam splitter is directed to the MEMS mirror and redirected by the MEMS mirror to the MEMS lens for focusing on an object.

19. The endoscopic imaging system according to claim 14, wherein the beam splitter is a polarizing beam splitter.
